(19) United States
(12) Patent Application Publication
(10) Pub. No.: US 2005/0193169 A1
(43) Pub. Date: Sep. 1, 2005

(54) Memory management

(76) Inventor: Manish K. Ahluwalia, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/790,509

(22) Filed: Mar. 1, 2004

(51) Int. Cl. G06F 12/08

(52) U.S. Cl. 711/115; 711/203; 711/154

(57) ABSTRACT

Systems, methods, and device are provided for memory management. One method embodiment includes tracking a virtual address space for a process associated with a removable, memory mappable device connected to a computing device. The method includes releasing a physical address space when the device has a logical connection removed from the computing device. The method further includes registering that the virtual address space is not available to the process in a manner which does not violate semantics of an operating system upon releasing the physical address space before the process has released the virtual address space.

### BACKGROUND

Before a computing device such as a desktop computer, laptop, server workstation, etc., may accomplish a desired task, it must receive an appropriate set of instructions. Executed by a device's processor(s), these instructions collectively referred to as a program direct the operation of the device. These instructions can be stored in a memory of the computer. Instructions can invoke other instructions. In executing program instructions computer program applications also retrieve other data from memory. When the execution of the program instructions call for data in memory the program will want to know where in memory the data is stored. In effect, the program will use a means for referencing or indexing where in memory the data is held. Early on in computing, data was retrieved from memory by using a physical address of the memory which represented where the particular data was held. Using this physical address, the program instructions would request this portion or particular piece of memory.

A more modem construct is to use what is referred to as “virtual memory”. Virtual memory is a technique within the memory management subsystem to allow the processor to access a larger memory space than the physical memory that actually exists in the processor system of a computing device. With many programs running on a computing device available physical memory space would quickly become an issue if all of the programs were to be assigned a physical memory address.

To illustrate, without virtual memory if there were only 100 slots of memory available those slots of memory would have to be divided up between the running programs. Not every program uses the same amount of memory. Moreover, it may be difficult to know in advance how much memory a program will use. For example, executing program instructions for a web browser may involve allocating enough memory to load lots of text and graphical content, e.g., in connection with loading a web page such as ABC.com. Alternatively, executing program instructions for the same web browser may involve allocating enough memory to load a limited amount of text and graphics, e.g., in connection with loading a web page for a search engine which may be much less content intensive. Without the correct allotment of memory the program will not be able to access something that the operating system of the computer has not given to the program. Blocking off too much memory inefficiently utilizes the amount of memory available. Additionally, the fact that the program applications themselves can be buggy complicates predicting in advance the amount of memory a program will use.

With virtual memory, a memory management system of the operating system (OS) sits in the middle between the program application and the physical memory. When a program requests memory the memory management system of the OS provides the program with a virtual memory address, e.g., a number between 0 and 1000. Thus, the memory management system of the OS may tell the program it owns memory at virtual address location 32. The memory management system of the OS then handles the overhead and mapping to an actual physical memory address. The operating system provides a base for writing and running program applications thereby freeing programmers from the details of computer system hardware. In addition, the operating system manages processes, memory, file systems, I/O systems, and the like.

In an operating system, a process refers to a running program with input, output, and a state. For example, a process includes the current values of the program counter, the registers, and the variables of an executing program. Each process has an “address space”. Further each process includes one or more threads associated with the “address space”. The thread is sometimes referred to as a lightweight process. Processes and threads are well known in the art and are described, for example, in Modern Operating Systems, Andrew S. Tannenbaum, (1992). Hence, running a process generally requires executing a thread and accessing the address space.

The operation of accessing an address space typically involves managing a memory system in the operating system. In particular, the operating system implements a virtual memory system to map a virtual address associated with a thread from a large virtual address space to a physical address of a physical memory, which is typically a RAM. The translation is transparent to the program. The memory management system of the OS tracks both assigning and releasing memory in connection with the multiple processes and threads. A computer system is not limited to a single virtual address space. Indeed, it may implement as many virtual address spaces as its operating system is capable of supporting. For example, modem operating systems often support multiple processors and multiple threads of execution, thereby allowing the sharing of the system resources and further providing multiple concurrent processes and threads that execute simultaneously. The virtual address spaces are usually separate from each other to prevent overlapping processes or data.

Many operating systems do not allow removable devices, e.g., I/O devices or otherwise, to be mapped into virtual memory. Still there are instances where it would be desirable to map removable I/O devices, circuit cards, controller cards, and the like to physical memory using a virtual memory address scheme.

Unfortunately, there are a number of issues created when a removable, memory mappable device is disconnected from the computing device while a process associated with the removable device has a virtual address space allocated to it. For example, when a removable device is disconnected from the computing device, the memory management system of the OS will proceed to release or free up the physical address space that was being used by the process associated with the removable device. However, in some operating systems the semantics do not allow one process or the kernel to unmap the virtual memory address space previously allocated to another process. The proper approach is for the process which requested the virtual memory address to initiate the release of its virtual address space. Additionally, according to operating system semantics it is not possible to state that the physical address space is not available since the memory management system of the OS has indeed released or freed this physical address space. Thus, without more action taken the memory management system may act as if the freed physical address space is available to associate with another virtual address allocation. In other words, it is possible that the memory management system of the OS may proceed to reallocate the physical address space to another process associated with another virtual address space.

Further complicating the issue is that if the process which requested the virtual address space has not released or freed the virtual address space, e.g., said it is no longer needed by the process, then it is possible that the process will continue trying to read and write data to the virtual address space even though the memory management system has freed the physical address space associated with that virtual address space for use by other processes. Hence, multiple processes may begin to conflict and foul one another up by reading and writing data into a physical memory address space which is not intended to be shared.

### BRIEF DESCRIPTION OF THE DRAWINGS

FIG. 1 is a diagram illustrating a system or computing device in which an embodiment of the invention can be practiced.

FIG. 2A illustrates an exemplary memory mapping method for mapping one or more virtual address spaces to a physical memory.

FIG. 2B illustrates a more detailed diagram of the exemplary virtual address space.

FIG. 2C illustrates another exemplary virtual memory data structure.

FIGS. 3A-3B illustrates a more detailed embodiment of a virtual memory data structure.

FIGS. 4-5 illustrate various method embodiments for memory management.

### DETAILED DESCRIPTION

Program instructions are provided which execute to remove a process's access to physical memory such as, for example, when a device associated with the process is disconnected from a computing device and the physical memory is released by a memory management system of the operating system (OS). In various embodiments, as a removable device is disconnected from the computing device the memory management system releases the physical address space associated with the removable device according to the operating system's semantics. If this occurs before the process that was allocated and/or assigned this virtual address space has released the virtual address space, then the program instructions execute to register in a virtual memory data structure associated with the process that the virtual address space, previously available to the process, is no longer valid for process use.

The program instructions execute to allow the process to unmap the virtual address space subsequent to the release of the virtual address space by the memory management system of the operating system, e.g. subsequent to when the removable device associated with the process was disconnected from the computing device. The program instructions additionally execute to indicate an operation as failed if the process attempts to perform the operation subsequent to registering in the virtual memory data structure that the virtual address space is no longer valid for process use. Thus, according to the various embodiments, the program instructions execute to unmap the virtual address space in a manner which does not violate semantics for the operating system of the computing device. As one example, as will be explained in more detail below, the program instructions can execute to perform out of process context unmaps without violating Unix semantics.

In the following description, for purposes of explanation, numerous details are set forth in order to provide a thorough understanding of the present invention. However, it will be apparent to one skilled in the art that these specific details are not required in order to practice the present invention. In other instances, well known electrical structures and circuits are shown in block diagram form in order not to obscure the present invention.

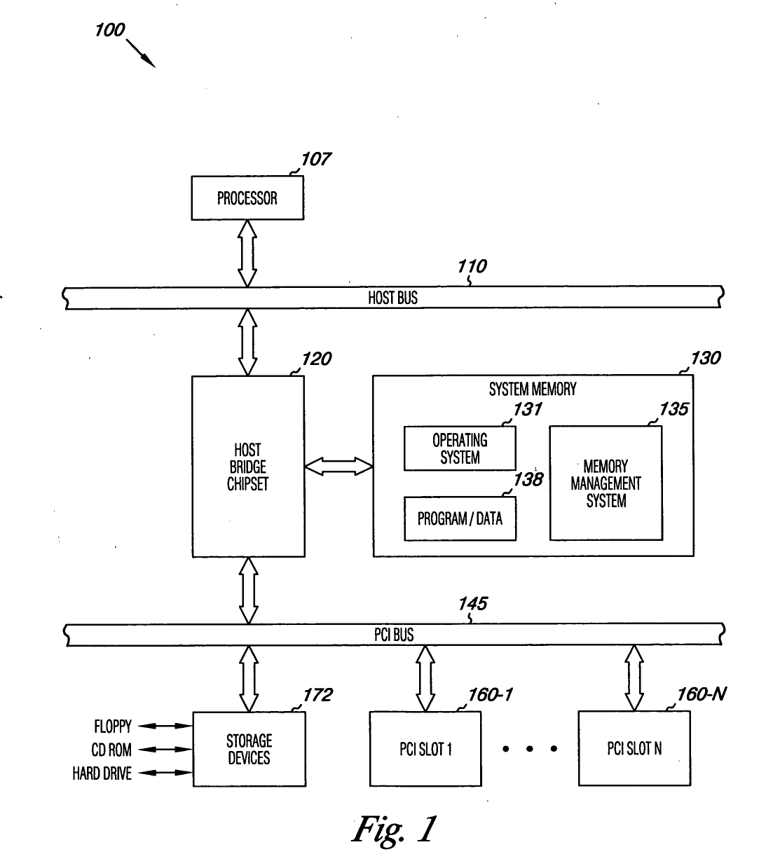

FIG. 1 is a diagram illustrating a system or computing device 100 in which one embodiment of the invention can be practiced. The system or computing device 100 shown illustrates a processor 105, a host bus 110, a host bridge chipset 120, a system memory 130, a peripheral component interconnect (PCI) bus 155, “N” (representing a scalable number) PCI slots 160-1 to 160-N (e.g., slots for I/O circuit cards, controller cards, and other removable devices), and one or more storage devices (e.g., disks, CDs, hard drives, removable memory, etc.), shown generally as 172.

The processor 105 represents a central processing unit of any type of architecture, such as complex instruction set computers (CISC), reduced instruction set computers (RISC), very long instruction word (VLIW) explicitly parallel instruction set computing (EPIC), or hybrid architecture. Embodiments of the invention can be implemented in a multi-processor or single processor system or computing device. Embodiments described herein can similarly be implemented in a distributed computing network environment, as the same are known and understood by one of ordinary skill in the art. The embodiments are not limited to the examples given herein.

The host bridge chipset 120 includes a number of interface circuits to allow the host processor 105 to access the system memory 130 and the PCI bus 155. The system memory 130 represents one or more mechanisms for storing information. For example, the system memory 130 may include non-volatile and/or volatile memories. Examples of these memories include flash memory, read only memory (ROM), or random access memory (RAM). The system memory 130 may be loaded with an operating system (OS) 131, e.g., in ROM, a memory management system 135, e.g., in RAM, and other programs and data 138. The system memory 130 may also contain additional software as the same will be known and understood by one of ordinary skill in the art. The memory management system 135 includes elements such as virtual memory data structures associated with various processes to support the management of memory in connection with program applications being executed by the processor 105. That is, as one of ordinary skill in the art will appreciate the memory management system includes programs, code, data, look-up tables, etc.

The PCI slots 160-1 to 160-N provide interfaces to PCI devices. Examples of PCI devices can include printers, removable disk storage and databases, facsimiles, scanners, network interface devices, media interface devices, etc. Embodiments of the present invention are directed to devices which can be mapped to memory and thus can include circuitry cards to controllers which control the operation of the above mentioned PCI devices as the same will be known and understood by one of ordinary skill in the art. As one of ordinary skill in the art will further appreciate, a logic circuit, input/output (1/O) card, circuit card, or other controller, can be mapped to memory for an I/O device. The I/O card, logic circuit, circuit card, or other controller, can be mapped to memory as an I/O space. For clarity, reference is made in this application to memory addresses. However, embodiments are also considered to include such memory mapped I/O space.

For example, network interface devices, as used herein, can include an I/O space which connects to communication channels such as the Internet to in turn provide access to on-line service providers, Web browsers, and other network channels. Media interface devices can include an I/O space and provide access to audio and video devices. Storage devices 172 as well may include an I/O space. Storage devices 172 can include CD ROMs, databases, disks, and hard drives. Embodiments, however, are not limited to these examples.

When implemented in software, the embodiments of the present invention are essentially the code segments to perform particular tasks. The program or code segments can be stored in a computer/processor readable medium or transmitted by a computer data signal embodied in a carrier wave, or a signal modulated by a carrier, over a transmission medium. A computer readable medium may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Modem systems and computing devices 100 employ operating systems to manage the computer systems' resources and provide a foundation for application programs running thereon. Examples of operating systems include, but are not limited to, Windows, Mac, Unix, Linux, etc.

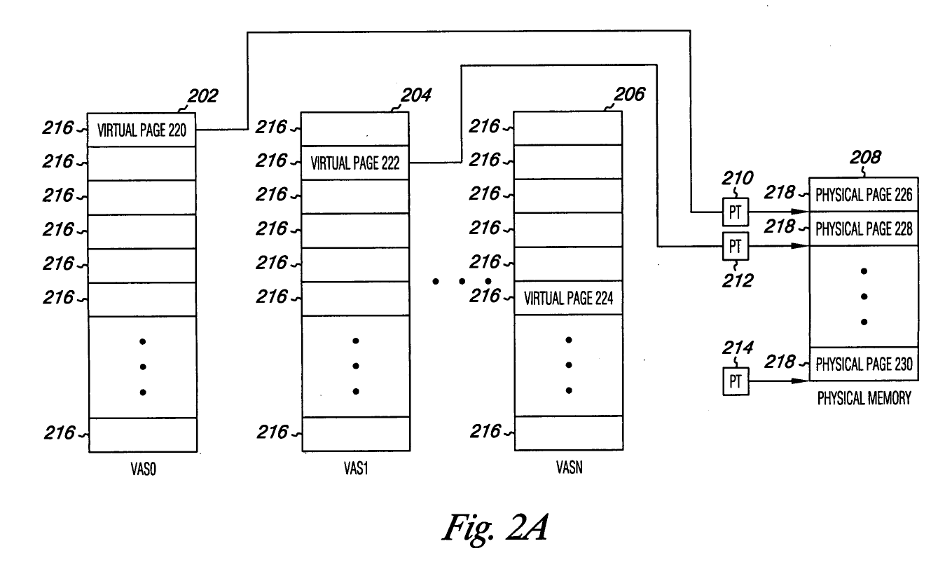

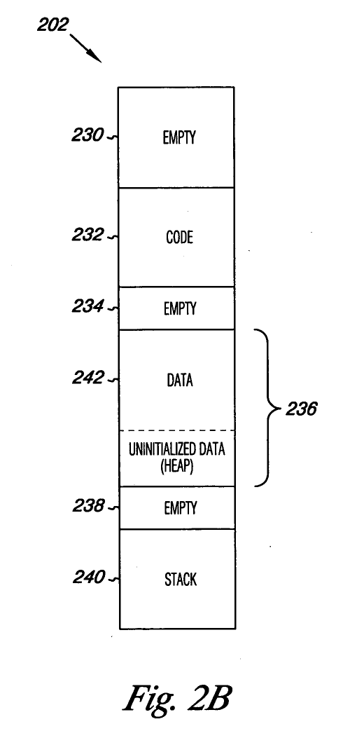

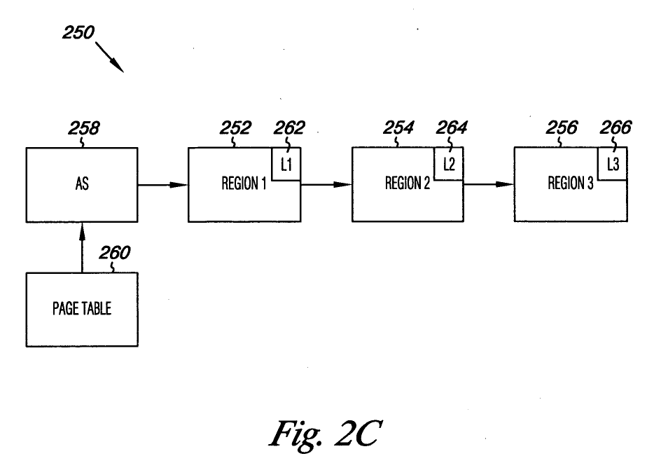

FIG. 2A illustrates an exemplary memory mapping method for mapping one or more virtual address spaces (or I/O spaces) to a physical memory. In FIG. 2A a number of virtual address spaces, e.g., 202 (VAS0), 204 (VAS1), and 206 (VASN) are shown. Each of the virtual address spaces 202, 204, and 206 can be provided with an associated page table for mapping virtual memory addresses to physical memory addresses as the same are known and understood by one of ordinary skill in the art. In the embodiment of FIG. 2A, the virtual address spaces 202, 204, and 206 are associated with page tables 210, 212, and 214, respectively. Each of the virtual address spaces has a plurality of virtual pages 216. A physical memory 208 also includes a plurality of physical pages 218. The virtual pages 216 and physical pages 218 are typically of same size and typically range from 4 kilobytes (KB) up to 16 KB. Embodiments, however, are not so limited and computer systems may employ any suitable page size, which can be selected by the operating system based on supporting hardware.

In this configuration, pages in the virtual address spaces 202, 204, and 206 are mapped to pages in the physical memory 208 via page tables 210, 212, and 214, respectively. For example, a virtual page 220 in the virtual address space 202 is mapped via page table 210 to physical page 226. Likewise, a virtual page 222 in the virtual address space 204 is mapped to physical page 228 through page table 212 while virtual page 224 of the virtual address space 206 is mapped to physical page 230 via page table 214. In those instances where a page is not present in the physical memory, a page fault is generated to load the page from a secondary storage device such as a hard drive, optical drive, tape drive, etc. Page mapping and page faults are well known in the art. It should be noted that page tables may be shared among several virtual address spaces. Indeed, even a portion of a page table may be shared among different address spaces.

FIG. 2B illustrates a more detailed diagram of the exemplary virtual address space. A virtual address space, in abstract terms, is typically divided into a plurality of regions in accordance with data types. FIG. 2B shows a more detailed diagram of the exemplary virtual address space 202. The virtual address space 202 is comprised of a plurality of regions 230, 232, 234, 236, 238, and 240. Each of the regions 230 through 240 is a contiguous region and the virtual pages within each region share common attributes. For example, the regions 230, 234, and 238 are empty regions that can be used to accommodate new data (e.g., files) from a secondary storage device or data from other contiguous regions 232, 236, and 240. The code region 232 corresponds to the address space of codes (e.g., text in Unix) such as programs, instructions, and the like. On the other hand, the data region 236 includes a pair of sub-regions 242 and 244 that corresponds to address spaces of data and uninitialized data (e.g., HEAP), respectively. Likewise, the stack region 240 corresponds to the address space of a stack. The operating system maintains attributes such as the start address and the length of each region so that each region can be tracked accurately.

As mentioned above, the virtual pages in each region share common attributes. For example, the code region 232 may have an attribute specifying a file on a hard drive from which instructions can be fetched. The stack region 240, on the other hand, usually grows dynamically and automatically downwards toward lower addresses and has an attribute that identifies it as a stack. Other common attributes include read and write attributes. For instance, the code region 232 is generally given an attribute of read only while data is associated with both read and write attributes. Other attributes also may be applied to any of the regions in a virtual address space.

In modern computer systems, operating systems generally allow multiple threads to execute virtually simultaneously in the virtual address space 202. For example, Unix and Linux operating systems allow multiple threads to concurrently execute in a single virtual address space. In such instances, the threads may be performing an operation that affects the address space at once. For example, multiple threads on multiple CPUs could simultaneously perform page faults. Multiple threads may also execute a system call (e.g., MMAP in Unix) to map a file from a secondary storage device into the address space. To accommodate the new file, the operating system may create a region in one of the empty regions 230, 234, or 238 of the virtual address space 202.

However, when multiple threads are attempting to access the same region in a virtual address space, a problem of contention arises. For example, if two threads are allowed to operate on the kernel data associated with the same virtual page in a region, the data may not be synchronized or updated properly. To address the contention problem, some memory management systems employ a “lock” to synchronize access by providing exclusive access to a thread such that other threads are not allowed to change the data accessed by the thread. In this manner, the lock ensures mutual exclusion of multiple threads for updates.

FIG. 2C is an exemplary virtual memory data structure illustrating the handling of mutual exclusion of multiple threads in a process for updates. Conventional methods typically have provided a lock for each region in a virtual address space. The virtual memory system portion of the operating system generally maintains the regions of a virtual address space as a data structure, which is kept in a memory. FIG. 2C shows a simplified data structure 250 using locks 262, 264, and 266 to provide exclusive access to regions 252, 254, and 256, respectively. The regions 252, 254, and 256 may correspond to a code region, data region, and stack region, respectively, and may be shared among different address spaces. It is noted that the word region is used herein in its most general form. In fact, it may actually be composed of multiple data structures within the kernel. The data structure 250 also includes an address space (AS) 258 that heads the virtual address space and maintains a pointer to the first region 252. In addition, the address space 258 includes a pointer to a page table 260 associated with the data structure 250. The data structure 250 may be provided for each virtual address space where the operating system provides multiple virtual address spaces. The data structures for all the virtual address spaces are stored in kernel memory in the operating system.

The regions 252, 254, and 256 are arranged as a linked list where the region 252 points to regions 254, which in turn points to region 256. However, the data structure 250 may be implemented by using any suitable arrangement such as arrays, trees, and the like. Each of regions 252, 254, and 256 is also a data structure and provides a pointer to locations such as files on a disk, flags for read/write permission, a flag for a stack, etc.

The data structures for the regions 252, 254, and 256 include the locks 262, 264, and 266, respectively. The lock 262 is used to provide a thread with exclusive access to the kernel data structures for the pages in the region 252. For example, the lock 262 is obtained and held to enable the thread to perform an operation that affects the kernel data structures corresponding to the virtual addresses in the region 252. When the thread finishes its operation, the lock 262 is released so that another thread can access the data structures. Similarly, the locks 264 and 266 are used to provide exclusive access to the data structures for the regions 254 and 256, respectively. As is well known in the art, the locks 262, 264, and 266 may be implemented using binary semaphore, monitor, etc.

As introduced above, a memory management system is designed to make memory resources available safely and efficiently to threads and processes. As will be described in more detail below, program embodiments execute to decide which threads and processes reside in physical memory and execute to manipulate threads and processes in and out of memory. The program embodiments additionally execute to manage the parts of the virtual address space of a thread or process not in physical memory and determine what portions of the address space should reside in physical memory.

To execute a process, the kernel creates a per-process virtual address space that is set up by the kernel. As used herein the term kernel refers to the fundamental part of a program, typically an operating system, that resides in memory at all times and provides the basic services. It is the part of the operating system that is closest to the machine and may activate the hardware directly or interface to another software layer that drives the hardware. Portions of the virtual space are mapped onto physical memory. Virtual memory allows the total size of user processes to exceed physical memory. Dereferencing a virtual address space refers to the kernel, e.g., operating system, executing threads and processes by bringing virtual pages into main memory as requested by a process. Pages are the smallest contiguous block of physical memory that can be allocated for storing data and code. The term object refers to an independent block of data, text or graphics that created by a program application and its associated processes. Every page of physical memory is addressed by a physical page number (PPN), which is a software reduction of the physical page number from the physical address. Access to pages is done through virtual addresses. When a virtual page is “paged” into physical memory, free physical pages are allocated to it by the physical memory allocator. These pages may be scattered throughout the memory depending on their usage history.

For a process to execute, all the structures for data, text, and so on have to be set up. However, pages are not loaded in memory until they are requested by a process. This allows the various parts of a process to be brought into physical memory as the process needs them to execute. The general repository for high speed data storage is random access memory (RAM) or “main memory.” For the processor to execute a process the code and data requested by that process must reside in the main memory. On each processor there are also registers and cache memory which are even faster than main memory. Actual program execution happens in registers, which get data from the cache and other registers. The cache contains the current working copy of parts of main memory. Most of the time when discussing memory management, cache and registers will be completely ignored; data and instruction will be treated as being accessed directly from main memory. The amount of main memory not reserved for the kernel is termed available memory. Available memory is used by the system for executing processes. Physical address space is the entire range of addresses used by hardware and is divided into memory address space, processor-dependent code (PDC) address space, and I/O address space.

As one of ordinary skill in the art will appreciate a processor architecture will typically include a translation lookaside buffer (TLB). The TLB translates virtual addresses to physical addresses. Address translation is handled from the top of the memory hierarchy hitting the fastest components first (e.g., the TLB on the processor) and then moving on to a page directory table (e.g., in main memory) and lastly to secondary storage. As one of ordinary skill in the art will appreciate the TLB look up the translation for the virtual page numbers (VPNs) and gets the physical page numbers (PPNs) used to reference physical memory. Essentially the TLB is a cache for address translations. The operating system maintains a table in memory called the page directory (PDIR) which keeps track of all virtual pages currently in memory. When a page is mapped in some virtual address space, it is allocated an entry in the PDIR. The PDIR is what links a virtual address to a physical page in memory. The PDIR can be implemented as a memory resident table of software structures called hashed page directory entries (HPDEs), which contain virtual and physical addresses. When the processor needs to find a physical page not indexed in the TLB, it can search the PDIR with a virtual address to find the matching address. Each page directory entry contains information on the virtual to physical address translation, along with other information for the management of each page of virtual memory.

As mentioned above, cache is fast, associative memory on the processor module that stores recently accessed instructions and data. From it, the processor learns whether it has immediate access to data or needs to go out to main memory for it. When a process executes, it stores code and data in processor registers for referencing. If the data or code is not present in the registers, the processor supplies the virtual address of the desired data to the TLB and to the cache controller. Registers, high speed memory in the processor, are used by the software as storage elements that hold data for instruction control flow, computations, interruption processing, protection mechanisms, and virtual memory management.

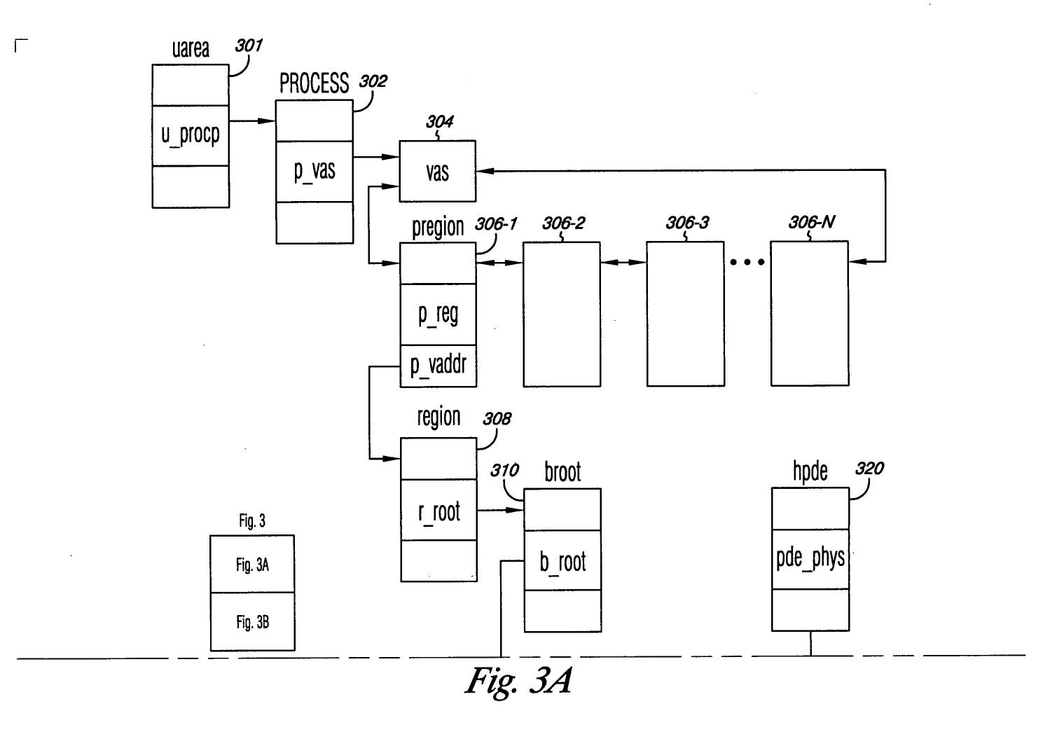

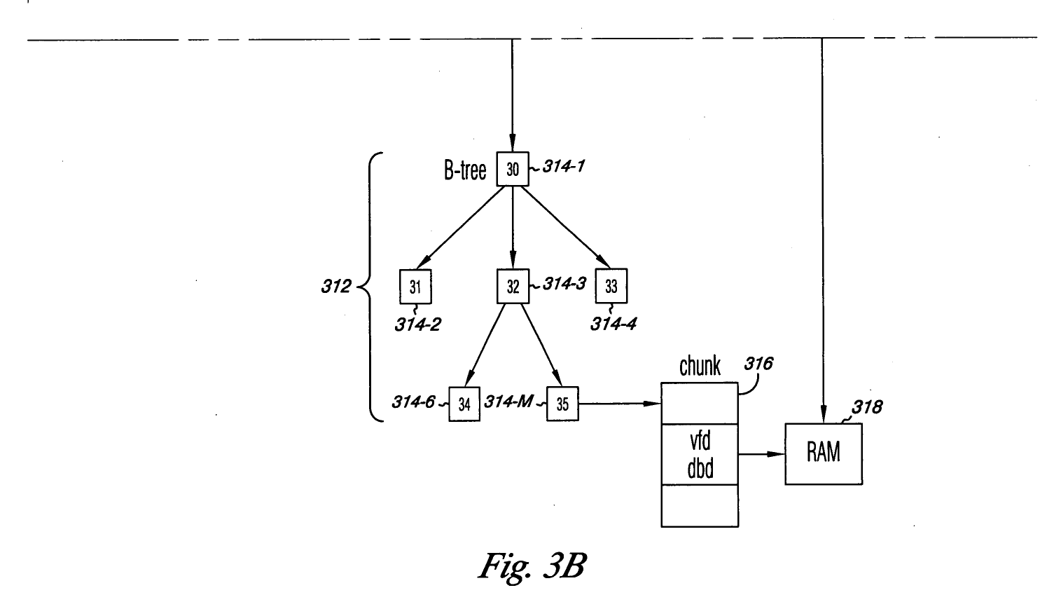

FIGS. 3A-3B illustrates a more detailed embodiment of a virtual memory data structure. Process management uses kernel structures down to the pregion, shown as 306-1, 306-2, 306-3, . . . , 306-N, to execute the threads of a process. The uarea 301, process 302 structure, vas (virtual address space) 304, and pregions, 306-1, 306-2, 306-3, . . . , 306-N, are per-process resources, because each process has its own unique copies of these structures, which are not shared among multiple processes. Below the pregion, e.g., 306-1, 306-2, 306-3, . . . , 306-N, level are the system wide resources. These structures can be shared among multiple processes (although they are not required to be shared). The memory management kernel structures map pregions, 306-1, 306-2, 306-3, . . . , 306-N, to physical memory and provide support for the processor's ability to translate virtual addresses to physical memory. The following is a summary of the structures involved in memory management. Vas 304 keeps track of the structural elements associated with a process in memory. One vas 304 is maintained per process. A pregion, e.g., 306-1, 306-2, 306-3, . . . , 306-N, is a per-process resource that describes the regions attached to the process. A region 308 is a memory resident system resource that can be shared among processes. The region 308 provides pointers which point to the process's b-tree 312, vnode, and pregions, 306-1, 306-2, 306-3, . . . , 306-N, as described in more detail below. The b-tree 312 is a balanced tree that stores pairs of page indices and chunk addresses. At the root of a b-tree 312 of virtual frame descriptors (VFDs) and disk block descriptors (DBDs) is the structure broot 310. A VFD is a one word structure that enables processes to reference pages of memory. The VFD is used when the process is in memory, and can be used to refer to the page of physical memory. When the page of data is not in memory but on disk, the DBD gives valid reference to the data. The HPDE 320 contains information for virtual to physical translation (that is, from VFD to physical memory).

The vas 304 represents the virtual address space of a process and serves as the head of a double linked list of process region data structures called pregions, 306-1, 306-2, 306-3, . . . , 306-N. The vas 304 data structure is memory resident. When a process is created, the system allocates a vas 304 structure and puts its address in p_vas, a field in the process structure 302. The virtual address space of a process is broken down into logical chunks of virtually contiguous pages. Each pregion, 306-1, 306-2, 306-3, . . . , 306-N, represents a process's view of a particular portion of its virtual address space and information on getting to those pages. The pregion, 306-1, 306-2, 306-3, . . . , 306-N, includes pointers which point to the region 308 data structure that describes the pages' physical locations in memory or in secondary storage. The pregion, 306-1, 306-2, 306-3, . . . , 306-N, also contains the virtual addresses to which the process's pages are mapped, the page usage (text, data, stack, and so forth), and page protections (read, write, execute, and so on). Elements within the pregion, 306-1, 306-2, 306-3, . . . , 306-N, include p_reg which is a pointer to the region attached by the pregion, 306-1, 306-2, 306-3, . . . , 306-N. Elements also include a p_vaddr which is a virtual address of the pregion, 306-1, 306-2, 306-3, . . . , 306-N, based on virtual space and virtual offset.

As mentioned above, the region 308 is a system wide kernel data structure that associates groups of pages with a given process. Regions can be one of two types, private (used by a single process) or shared (able to be used by more than one process). Regions 308 are pointed to by pregions, 306-1, 306-2, 306-3, . . . , 306-N, which are a per-process resource. Region fields such as r_root are used to find information about the individual pages of a region 308. Each page is represented by a VFD if it is in memory or DBD if it is on disk. For each page, the VFD and DBD are grouped together into a structure shown in the chunk 316 as vfddbd. Since information is typically needed about groups of (rather than individual) pages, pages are grouped into chunks 316. A chunk 316 contains 32 or 64 pairs of virtual frame descriptors and disk block descriptors. The kernel looks for a page in memory by its VFD. The kernel looks for a page on disk by its DBB. A one to one correspondence is maintained between VFD and DBD through the vfddbd structure, illustrated in the chuck structure 316, which contains one VFD and one DBD. As one of ordinary skill in the art will appreciate, regions 308 use chunks 316 of VFDs and DBDs to keep track of page ownership. For example, the regions 308 can use chunks 316 for assignment from virtual page to physical page if the page is valid, e.g., this may be required in addition to the PDIR. The regions 308 can use chunks 316 to obtain other virtual attributes of the page, e.g., whether the page is locked in memory, or whether it is valid. Embodiments, however, are not limited to these examples.

As shown in FIG. 3, each region 308 contains either a single array of vfddbds, e.g., chunk 316, or a pointer to a B-tree 312. As one of ordinary skill in the art will appreciate, the structure called a B-tree 312 allows for quick searches and efficient storage of sparse data. A bnode, e.g., 314-1, 314-2, . . . , 314-M, is the same size as a chunk 316; both can be retrieved from the same source of , memory. The region's 308 B-tree 312 stores pairs of page indices and chunk 316 addresses. A B-tree 312 is searched with a key and yields a value. In the region B-tree 312, the key is the page number in the region 308 divided by the number of vfddbds in a chunk 316. Each node, e.g., 314-1, 314-2, . . . , 314-M, of a B-tree 312 contains room for order +1 keys (or indexed numbers) and order +2 values. If a node grows to contain more than order keys, it is split into two; half of the pairs are kept in the original node and the other half are copied to the new node. The B-tree 312 node data also includes the number of valid elements contained in that node. As shown in the embodiment of FIG. 3, a structure called broot 310 includes a pointer which points to the start of the B-tree, e.g. 314-1 in 312.

Since today in many computing devices and system a much larger variety of input/output (I/O) devices are being mapped to memory, the program embodiments described herein provide a technique to track a virtual address space for a process associated with a removable, memory mappable device connected to the computing device, e.g., the computing device or system shown in FIG. 1.

In the various embodiments, program instructions execute to release a physical address space associated with the virtual address space when the device has a connection removed from the computing device. Additionally, the program embodiments execute to register that the virtual address space, previously available to the process, is no longer valid for process use. As used herein, the virtual address space may include an input/output space. The program instructions are part of a memory management system which includes a virtual memory data structures shown and discussed in connection with FIG. 3. As will be described in more detail below, the program instructions execute to register that the virtual address space is no longer valid for process use in the virtual memory data structure.

As described in connection with FIGS. 1-3 the program instructions execute to allocate a virtual address space when a process requests physical memory. And, the program instructions execute to register that the virtual address space is available for use when the process releases the virtual address space. As one of ordinary skill in the art will appreciate from reading this disclosure a computing device having a processor, a memory (e.g., RAM) coupled to the processor, and program instructions provided to the memory and executable by the processor as part of a memory management system will execute to dereference a virtual address space for a process associated with a removable, memory mappable device connected to the computing device. The program instructions execute to release a physical address space associated with the virtual address space when the device associated with the process is logically or physically disconnected. And, the program instructions execute to register in a virtual memory data structure of the memory management system that the virtual address space is no longer available to the process.

To achieve this, the program instructions execute to unmap the virtual address space in a manner which does not violate semantics for an operating system of the computing device, e.g., a computing device having a Unix operating system. For example, referring to FIG. 3, in various embodiments the program instructions execute to maintain a representation of an object associated with the process in the virtual memory data structure of the process, e.g., in the pregion data structure shown in FIG. 3. Meanwhile, the program instructions can execute to remove a mapping of the object to physical memory. Additionally, the program instructions execute to register in the virtual memory data structure of the process, e.g., shown in FIG. 3, that the virtual address space associated with the process is not available for use. By way of example and not by way of limitation, the program instructions execute to set a bit in a region, e.g., 308 in FIG. 3, of the virtual memory data structure to indicate that the virtual address space in not available for use. In this manner, the program instructions execute to indicate an operation as failed if the process attempts to perform the operation subsequent to registering that the virtual address space is no longer valid for process use. And, the program instructions can execute to allow the process to unmap the virtual address space subsequent to the release of the physical address space.

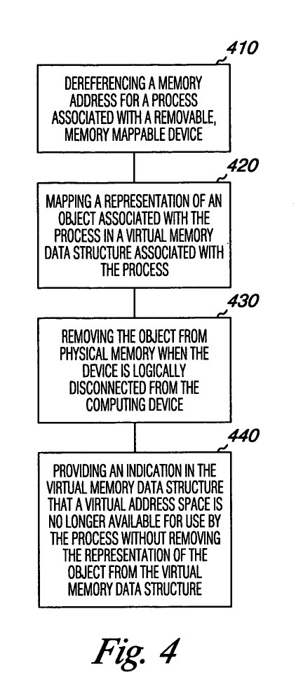

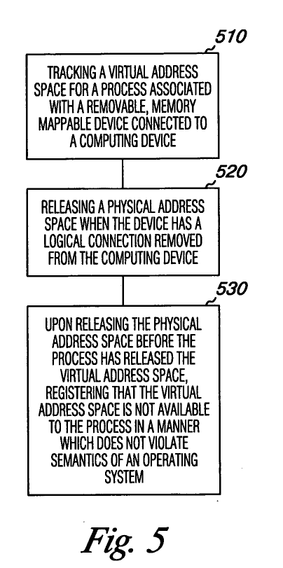

FIGS. 4-5 illustrate various method embodiments for memory management. As one of ordinary skill in the art will understand, the embodiments can be performed by software, application modules, and computer executable instructions operable on the systems and devices shown herein or otherwise. The invention, however, is not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments can occur or be performed at the same point in time.

FIG. 4 illustrates one method embodiment for memory management on a computing device, e.g., computing device and/or system shown in FIG. 1. As shown at block 410 in the embodiment of FIG. 4 the method includes dereferencing a memory address for a process associated with a removable, memory mappable device, such as can be located slots 160-1, . . . , 160-N in FIG. 1 (e.g., I/O device, circuit card, controller card, etc.). At block 420, the method further includes mapping a representation of an object associated with the process in a virtual memory data structure associated with the process, e.g., mapping a representation of the object into the pregion data structure shown as 306-1, . . . , 306-N, etc., in FIG. 3. The method further includes removing the object from physical memory when a removable memory mappable device is logically disconnected from the computing device as shown in block 430.

At block 440, the method further includes providing an indication in the virtual memory data structure that a virtual address space is no longer available for use by the process. According to embodiments of the invention, the method in block 440 includes providing an indication without removing the representation of the object from the virtual memory data structure. That is, in various embodiments, an indication is provided in the virtual memory data structure without removing the representation of the object from the “pregion” data structure shown as 306-1, . . . , 306-N, etc., in FIG. 3.

According to various embodiments, providing an indication in the virtual memory data structure includes program embodiments (e.g., computer executable instructions) which execute to set a bit in the “region” data structure, e.g., data structure 308 in FIG. 3. In other various embodiments, the program embodiments execute instructions to set a bit in the “broot” data structure, e.g., data structure 310 in FIG. 3. In other various embodiments, the program embodiments execute instructions to set a bit in the “B-tree” data structure, e.g., data structure 312 in FIG. 3. In other various embodiments, the program embodiments execute instructions to set a bit in the “chunk” data structure, e.g., data structure 316 in FIG. 3. Embodiments of the invention, however, are not so limited to these examples and one of ordinary skill in the art will appreciate upon reading this disclosure the manner in which program embodiments, as described herein, can execute to set a bit, several bits, flag, or other suitable identifier in one and/or a combination of data structures in the virtual memory data structure to mark that a virtual address space is no longer available for use by the process while maintaining a representation of the object associated with the process in the virtual memory data structure, e.g., in the “pregion” data structure 306-1, . . . , 306-N associated with the process as illustrated in FIG. 3.

The program instructions execute to mark a location within a virtual memory data structure associated with a given process that the virtual address space allocated to the process is no longer available for use when a memory mappable device associated with that process is logically removed, e.g., powered off, physically removed, or otherwise. And, the program instructions execute to maintain a representation of an object, e.g., block of data, text or graphics, that was created by that process and had a virtual address space allocated to it in the virtual memory data structure as well. By providing such an indication, the program instructions described herein can execute to indicate an operation as failed if the process attempts to perform the operation subsequent to the memory mappable device being logically disconnected from the computing device. And, the program instructions associated with the process can in their regular manner execute to release the particular allocated virtual address space at the process's request subsequent to the memory mappable device being logically disconnected from the computing device. Thus, according to the method embodiments described herein program instructions execute to effectively unmap a virtual address space associated with a process without violating the semantics of an operating system of a computing device.

FIG. 5 illustrates another method embodiment for memory management on a computing device, e.g., computing device and/or system shown in FIG. 1. As shown in FIG. 5 the method includes tracking a virtual address space for a process associated with a removable, memory mappable device connected to a computing device as shown in block 510. Tracking a virtual address space for a process includes dereferencing a memory address space and using a memory management system to create a virtual memory data structure for a given process requesting memory as described above in FIGS. 1-3.

Embodiments of the invention, allow removable devices, e.g., I/O devices, circuit cards, controller cards, and the like, to be mapped to using a virtual memory address scheme. As noted earlier, such removable devices can be logically and/or physically disconnected from a computing device. As shown at block 520, the operating system of the computing device will execute instructions to release the physical memory, e.g., the physical address space, which was being used by processes associated with a particular removable device when that particular device has a logical and/or physical connection removed from the computing device. As described above, the operating system itself does not perform the role of unmapping the virtual address space as this is the role of the process which requested the memory address space and was allocated a virtual memory address space in connection therewith. As a result, in cases where operating system semantics do not allow an object that was by one process to be unmapped by another, the processes associated with the particular removable device may well still be allocated and be using a virtual address space that is mapped to the now released physical address space.

Ordinarily, this would potentially permit multiple processes to begin to conflict and foul one another up by reading and writing data into a virtual memory address space which is not intended to be shared. As shown in block 530, however, program embodiments of the present invention operate to prevent this from occurring by executing to register that the virtual address space is not available to the process, or processes (e.g., associated with the particular removable device) in a manner which does not violate semantics of a given operating system. The program embodiments can execute to register that the virtual address space is not available to the process, or processes, according to any of the methods discussed and described above in connection with FIG. 4. As described in connection with FIG. 4, the program instructions which execute to register the virtual address space is not available additionally execute to maintain a representation of an object that was created by that process and had a virtual address space allocated to it in the virtual memory data structure. As one of ordinary skill in the art will appreciate upon reading this disclosure the above program instructions can be triggered to execute upon detection that the operating system has released a physical address space which was being used by processes associated with a particular removable device that had been mapped to memory using a virtual address scheme.

One example of the above described method embodiments, can be presented in connection with a network interface device and a media access device provided to PCI slots, such as slots 160-1, . . . , 160-N shown in FIG. 1. One of ordinary skill in the art will appreciate that the embodiments covered by this disclosure are not limited to this example and that embodiments can similarly be used in connection with other types of I/O cards, logic circuits, circuit cards, or controllers (as the same are known and understood) in instances which these devices are being mapped to physical memory in a computing device using a virtual memory address scheme. The example given herein presumes a media interface device and a network interface device which are both being virtually mapped to physical memory as I/O spaces and which can be logically removed without a particular process knowing about it. As mentioned above, a media interface device can include an I/O space to access audio and video devices, as network interface device can include an I/O space which connects to communication channels such as the Internet to in turn provide access to on-line service providers, Web browsers, and other network channels.

As described above, a process refers to a running program with input, output, and one or more states. Thus, for example, a web browser program running on a computing device may have many different processes executing to request memory. Moreover, a number of web browser programs may be running at the same time. That is, executing program instructions for a web browser may involve a process in connection with loading a web page such as ABC.com. This process will involve allocating enough memory to load lots of text and graphical content. Other program instructions for a web browser may involve a process in connection with loading a web page for a search engine such Google.com. Thus, multiple processes can be requesting a virtual address space (shown in FIG. 3 as 302 and 304, respectively).

As one of ordinary skill in the art will appreciate, a program is really a bundle of processes. A process, as used herein, is an application that is running. Each process can have multiple threads or components. A process, or application that is running will be attempting to do some particular task or job such as opening a web page, e.g., contact the ABC web server. This process may have 11 different threads of execution. For example, one thread may be the text for the web page and another ten threads may involve graphics for the web page. As noted above, the entire address space for this application may be shared by all of these threads and said to belong to this process. As memory needs to load one image the program may call for slots of memory in which case the operating system may assign slots. A second thread may call to load another image and the program may call for another set of slots of memory in which case the OS may assign additional slots. These slots may be shared in which case both threads can access one another's memory slots. The program may additionally call for other slots of memory to write to which is private, e.g., not shared, to the program.

In this example, a process and its threads in connection with the network interface device, e.g., associated with the ABC.com web page launch, will request a virtual address space, e.g., a number of slots of memory including pages of virtual memory. The memory management system of the operating system (OS) will handle the overhead of allocating a virtual address space to the process. In the virtual memory data structure embodiment of FIG. 3, this is illustrated by “p_vas” being given to the process 302 with an associated virtual address space (vas) 304. For example, when the process and its associated threads requests a number of slots of memory, e.g., 5 pages of memory, the memory management system of the OS may allocate a virtual address as 30-34 representing 5 pages of virtual memory (e.g., pages 30, 31, 32, 33, 34). This is then the virtual address space (vas) 302 for the process. The memory management system may refer to this virtual address space 302 by its first page, e.g., 30, and may register that there are a total of 5 pages, e.g., a virtual address count of 5. As shown in the virtual memory data structure embodiment of FIG. 3 a “pregion” data structure, 306-1, . . . , 306-N, will be linked to this vas 302. In FIG. 3, pregion data structure 306-1 illustrates a “p_vaddr” which may identify the virtual address by its first page, e.g., 30. Each of the threads will have a virtual page address, e.g., 30, 31, 32, 33, and 34 which can be correlated to a physical page of memory as registered in the hash-table “hpde” 320 shown in FIG. 3.

As another process and its threads, e.g., the process associated with media interface device, requests a virtual address space the memory management system of the operating system (OS) will again handle the overhead of allocating a virtual address space to the process. The process and its threads associated with the media interface device may, for example, request an additional 3 pages of memory. Here the memory management system may allocate another virtual address space 36-38. The memory management system may again refer to this virtual address space by its first page 36 and may register that there are a total of 3 pages, e.g., a virtual address count of 3.

One of ordinary skill in the art will appreciate that the memory management system does not have to assign virtual address spaces in numerical order and that the above description is by way of example only. As described above, the memory management system will handle translation of the above virtual address spaces to physical address spaces in a manner which is transparent to the processes using these virtual address spaces.

As noted above, however, for resource efficiency, the memory management system of the OS will want to free up access to memory slots which are no longer being used. That is, the memory management system of the OS will continually want to make released address spaces available to other processes. Thus, the memory management system of the OS is involved with the mapping and unmapping of physical and virtual address spaces. However, as mentioned above, this mapping and unmapping is transparent to the program and performed according to operating system semantics. Thus removable devices, when mapped to physical memory using a virtual memory address scheme, can create data conflict within the virtual memory address scheme when physical memory being used by processes associated with a removable device is removed by the operating system due to such a removable, memory mappable device being physically and/or logically disconnected from the computing device.

For instance, using the above example, if the network interface device is physically and/or logically disconnected from the computing device while one or more processes associated with the network interface device are still allocated virtual memory address spaces, then the physical memory address space associated with those process may be freed by the operating system without the processes knowing so. As such these processes may continue to execute operations in connection with its allocated virtual address space, e.g., virtual page addresses 30, 31, 32, 33, and 34, and those operations may be lost and/or corrupt other data that has been placed in physical memory subsequently associated with another virtual memory address space. That is, once the physical memory associated with virtual address space is freed, the memory management system may allocate the free physical memory space to virtual address space 36-38 later allocated to a process for the media interface.

According to the embodiments described herein, however, this situation is prevented and prevented in a fashion which does not violate operating system semantics. By not violating operating system semantics it is intended that the memory management system of the OS not be able to register that the physical memory space is not free to allocate with other processes, and associate other virtual address spaces therewith, when the physical memory space is indeed free. And, likewise, that the process belonging to the launch of ABC.com not be instructed that it has not been allocated virtual memory address space 30, e.g., virtual page addresses 30, 31, 32, 33, and 34, when indeed it has. In other words, operating system semantics can be violated by the virtual address space one process being unmapped by another, e.g., the virtual address space of the process belonging to the launch of ABC.com being unmapped by a process belonging to the media interface device. It is rather up to the process associated with the launch of ABC.com to request the release of its virtual memory address space.

As described in detail above, this scenario is avoided since the program embodiments execute to maintain a representation of the object associated with the process for the ABC.com launch in the virtual memory data structure associated with that process and as such the process can subsequently request to release this virtual memory space. Additionally, this scenario is avoided since the program embodiments execute to register in that same virtual memory data structure, e.g., associated with the ABC.com launch, that the virtual memory address space is no longer available to the process. Accordingly, embodiments of the invention, allow removable devices, e.g., I/O devices, circuit cards, controller cards, and the like, to be mapped to using a virtual memory address scheme.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computing device, comprising:
a processor;
a memory coupled to the processor; and
program instructions provided to the memory and executable by the processor to:
track a virtual address space for a process associated with a device connected to the computing device;
release a physical address space associated with the virtual address space when the device has a connection removed from the computing device; and
register that the virtual address space, previously available to the process, is no longer valid for process use before the process has released the virtual address space.

2. The computing device of claim 1, wherein the device includes a device which can be mapped to memory.

3. The computing device of claim 1, wherein the virtual address space includes an input/output space.

4. The computing device of claim 1, wherein the program instructions are part of a memory management system which includes a virtual memory data structure associated with the process.

5. The computing device of claim 4, wherein the program instructions execute to register the virtual address space is no longer valid for process use in the virtual memory data structure associated with the process.

6. The computing device of claim 1, wherein the program instructions execute to allocate the virtual address space when the process requests physical memory.

7. The computing device of claim 1, wherein the program instructions execute to register that the virtual address space is available for use when the process releases the virtual address space.

8. A computing device, comprising:
a processor;
a random access memory coupled to the processor; and
program instructions provided to the memory and executable by the processor, the program instructions are part of a memory management system to:
dereference a virtual address space for a process associated with a removable, memory mappable device connected to the computing device;
release a physical address space associated with the virtual address space when the device associated with the process is logically disconnected; and
register in a virtual memory data structure of the memory management system that the virtual address space is no longer available to the process when the process has not yet released the virtual address space.

9. The computing device of claim 8, wherein the program instructions execute to unmap the virtual address space in a manner which do not violate semantics for an operating system the computing device.

10. The computing device of claim 9, wherein the operating system is selected from the group of a Unix operating system and a Linux operating system.

11. The computing device of claim 8, wherein the program instructions execute to allow the process to unmap the virtual address space subsequent to the release of the physical address space.

12. The computing device of claim 8, wherein the program instructions execute to indicate an operation as failed if the process attempts to perform the operation subsequent to registering that the virtual address space is no longer valid for process use.

13. A computing device, comprising:.
a processor;
a memory coupled to the processor, the memory including program instructions for maintaining a virtual memory data structure as part of a memory management system; and
means for unmapping a virtual address space for a process in a manner which does not violate semantics for an operating system of the computing device when a removable, memory mappable device associated with the process is logically disconnected.

14. The computing device of claim 13, wherein the program instructions execute to dereference the virtual address space for the process.

15. The computing device of claim 13, wherein the means for unmapping the physical address space includes program instructions which execute to maintain a representation of an object associated with the process in the virtual memory data structure of the process.

16. The computing device of claim 15, wherein the means for unmapping the physical address space includes program instructions which execute to remove a mapping of the object to physical memory.

17. The computing device of claim 13, wherein the means for unmapping the physical address space includes program instructions which execute to register in the virtual memory data structure of the process that the virtual address space associated with the process is not available for use.

18. The computing device of claim 17, wherein the program instructions execute to set a bit in a pregion of the virtual memory data structure to indicate that the virtual address space in not available for use.

19. A method for memory management on a computing device, comprising:
dereferencing a memory address for a process associated with a removable, memory mappable device;
mapping a representation of an object associated with the process in a virtual memory data structure associated with the process;
removing the object from physical memory when the device is logically disconnected from the computing device; and
providing an indication in the virtual memory data structure that a virtual address space is no longer available for use by the process without removing the representation of the object from the virtual memory data structure.

20. The method of claim 19, further including unmapping the virtual address space at the request of the process subsequent to the device being logically disconnected from the computing device.

21. The method of claim 19, further including indicating an operation as failed if the process attempts to perform the operation subsequent the device being logically disconnected from the computing device.

22. A method for memory management, comprising:
tracking a virtual address space for a process associated with a removable, memory mappable device connected to a computing device;
releasing a physical address space when the device has a logical connection removed from the computing device; and
upon releasing the physical address space before the process has released the virtual address space, registering that the virtual address space is not available to the process in a manner which does not violate semantics of an operating system.

23. A computer readable medium having a program to cause a device to perform a method, comprising:
dereferencing a virtual address space for a process associated with a removable, memory mappable device as part of a memory management system on a computing device;
releasing a physical address space when the device is logically disconnected from the computing device; and
upon releasing the physical address space before the process has released the virtual address space, registering in a virtual memory data structure associated with the process that the virtual address space is no longer available to the process in a manner which does not violate semantics for an operating system the computing device.
